(19) United States
(12) Patent Application Publication
(10) Pub. No.: US 2023/0343146 A1
(43) Pub. Date: Oct. 26, 2023

(54) VEHICLE REMOTE DIAGNOSIS SERVICE SYSTEM AND METHOD

(71) Applicants: Hyundai Motor Company, Seoul (KR); Kia Corporation, Seoul (KR)

(72) Inventors: Do Geun JUNG, Suwon-Si (KR); Sun Woo KIM, Seoul (KR); Woo Yeon LEE, Bucheon-Si (KR); Dong Young KIM, Seoul (KR); Yong Jin KIM, Seoul (KR)

(73) Assignees: Hyundai Motor Company, Seoul (KR); Kia Corporation, Seoul (KR)

(21) Appl. No.: 17/972,296

(22) Filed: Oct. 24, 2022

(30) Foreign Application Priority Data
Apr. 25, 2022 (KR) 10-2022-0050887

(51) Int. Cl. G07C 5/00; G06F 8/65

(52) U.S. Cl. CPC G07C 5/008; G06F 8/65

(57) ABSTRACT

A vehicle remote diagnosis service system includes a remote diagnosis server that transmits a first collection rule to at least one vehicle; and the vehicle that transmits an identification number and a failure detection signal collected according to the first collection rule to the remote diagnosis server when a failure corresponding to the first collection rule has occurred, and transmits information collected according to a second collection rule to the remote diagnosis server when the second collection rule is received from the remote diagnosis server.

### CROSS-REFERENCE TO RELATED APPLICATION

The present application claims priority to Korean Patent Application No. 10-2022-0050887, filed on Apr. 25, 2022, the entire contents of which is incorporated herein for all purposes by this reference.

### BACKGROUND OF THE PRESENT DISCLOSURE

### Field of the Present Disclosure

The present disclosure relates to a vehicle remote diagnosis service system and method.

### Description of Related Art

With the recent development of connectivity technology, a vehicle adopting the connectivity technology collects vehicle data according to default collection rules and transmits the vehicle data to a server, and the server analyzes the vehicle data received from the vehicle and provides a customized preemptive service to a driver.

When a new collection rule is applied to the vehicle, the previous collection rule is updated to a new version. In the instant case, when the previous collection rule is being executed, initialization may be performed, resulting in deletion of the previously collected information. Furthermore, when the collection rule is applied to the vehicle, it is necessary to monitor the execution conditions of all collection rules applied to the vehicle, causing an increase in the load of the vehicle. Accordingly, there is a need to develop a technology for optimizing a collection rule for collecting vehicle data and applying it to a vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle remote diagnosis service system and method capable of applying a failure information collection rule only to a malfunctioning vehicle to collect failure-related data only from the malfunctioning vehicle, and even when a collection rule previously applied to the vehicle is being executed, allowing a new collection rule to be applied to the vehicle without initialization.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle remote diagnosis service system includes a remote diagnosis server that transmits a first collection rule to at least one vehicle, and the vehicle that transmits an identification number and a failure detection signal collected according to the first collection rule to the remote diagnosis server when a failure corresponding to the first collection rule has occurred, and transmits information collected according to a second collection rule to the remote diagnosis server when the second collection rule is received from the remote diagnosis server.

The remote diagnosis server may transmit the first collection rule, which includes a condition for detecting the failure and collection of the failure detection signal under the condition, to the at least one vehicle.

The remote diagnosis server may constantly update the first collection rule to collect the condition for detecting the failure and the failure detection signal under the condition.

The remote diagnosis server may perform setting to automatically transmit the second collection rule to the vehicle that has transmitted the identification number when the remote diagnosis server receives the identification number and the failure detection signal.

The remote diagnosis server may transmit the second collection rule to allow the vehicle that has transmitted the identification number to collect failure-related information, to the vehicle.

The vehicle may automatically execute the second collection rule when the second collection rule is received from the remote diagnosis server.

The remote diagnosis server may transmit a plurality of second collection rules to a vehicle server when there is the plurality of second collection rules.

The vehicle server may determine to allow the vehicle to maintain or update each of the second collection rules according to setting information of each second collection rule when the vehicle server receives the plurality of second collection rules.

The vehicle may execute a (2-n)-th collection rule when the vehicle server determines to update the (2-n)-th collection rule among the plurality of second collection rules and there is no (2-m)-th collection rule being executed among the plurality of second collection rules.

The vehicle may determine to queue the (2-n)-th collection rule when the vehicle server determines to update the (2-n)-th collection rule among the plurality of second collection rules and there is the (2-m)-th collection rule being executed among the plurality of second collection rules, and execute the (2-n)-th collection rule when execution of the (2-m)-th collection rule has been completed.

According to an aspect of the present disclosure, a vehicle remote diagnosis service method includes transmitting, by a remote diagnosis server, a first collection rule to at least one vehicle, transmitting, by the vehicle, an identification number and a failure detection signal collected according to the first collection rule to the remote diagnosis server when a failure corresponding to the first collection rule has occurred in the vehicle, and transmitting, by the vehicle, information collected according to a second collection rule to the remote diagnosis server when the second collection rule is received from the remote diagnosis server.

The transmitting of the first collection rule to the at least one vehicle in the remote diagnosis server may include transmitting, by the remote diagnosis server, the first collection rule, which includes a condition for detecting the failure and collection of the failure detection signal under the condition, to the at least one vehicle.

The vehicle remote diagnosis service method may further include constantly updating, by the remote diagnosis server, the first collection rule to collect the condition for detecting the failure and the failure detection signal under the condition.

The vehicle remote diagnosis service method may further include performing, by the remote diagnosis server, setting to automatically transmit the second collection rule to the vehicle that has transmitted the identification number when the remote diagnosis server receives the identification number and the failure detection signal.

The vehicle remote diagnosis service method may further include transmitting, by the remote diagnosis server, the second collection rule to allow the vehicle that has transmitted the identification number to collect failure-related information, to the vehicle, after the transmitting of the identification number and the failure detection signal collected according to the first collection rule to the remote diagnosis server.

The vehicle remote diagnosis service method may further include automatically executing, by the vehicle, the second collection rule when the second collection rule is received from the remote diagnosis server.

The transmitting of the second collection rule may include transmitting, by the remote diagnosis server, a plurality of second collection rules to a vehicle server when there is the plurality of second collection rules.

The vehicle remote diagnosis service method may further include determining, by the vehicle server, to allow the vehicle to maintain or update each of the second collection rules according to setting information of each second collection rule when the vehicle server receives the plurality of second collection rules.

The vehicle remote diagnosis service method may further include executing, by the vehicle, a (2-n)-th collection rule when the vehicle server determines to update the (2-n)-th collection rule among the plurality of second collection rules and there is no (2-m)-th collection rule being executed among the plurality of second collection rules.

The vehicle remote diagnosis service method may further include queueing, by the vehicle, a (2-n)-th collection rule when the vehicle server determines to update the (2-n)-th collection rule among the plurality of second collection rules and there is the (2-m)-th collection rule being executed among the plurality of second collection rules, and execute the (2-n)-th collection rule when execution of the (2-m)-th collection rule has been completed.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a configuration of a vehicle remote diagnosis service system according to an exemplary embodiment of the present disclosure;

FIG. 2 is a diagram illustrating a configuration of a vehicle according to an exemplary embodiment of the present disclosure;

FIG. 3 is a diagram illustrating a configuration of a vehicle server according to an exemplary embodiment of the present disclosure;

FIG. 4 is a diagram illustrating a configuration of a remote diagnosis server according to an exemplary embodiment of the present disclosure;

FIG. 5, FIG. 6 and FIG. 7 are diagrams illustrating a vehicle remote diagnosis service method according to an exemplary embodiment of the present disclosure; and

FIG. 8 is a diagram illustrating a configuration of a determining system for executing a method according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

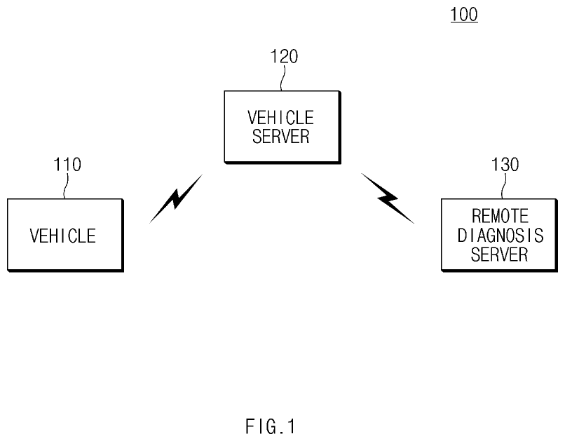

FIG. 1 is a diagram showing a configuration of a vehicle remote diagnosis service system according to an exemplary embodiment of the present disclosure.

Referring to FIG. 1, a vehicle remote diagnosis service system 100 according to an exemplary embodiment of the present disclosure may include a vehicle 110, a vehicle server 120, and a remote diagnosis server 130.

When receiving a first collection rule from the remote diagnosis server 130, the vehicle 110 may determine whether a failure corresponding to the first collection rule has occurred. When it is determined that the failure corresponding to the first collection rule has occurred, the vehicle 110 may transmit an identification number and a failure detection signal, which are collected according to the first collection rule, to the remote diagnosis server 130. When a second collection rule is received from the remote diagnosis server 130, the vehicle 110 may transmit information collected according to the second collection rule to the remote diagnosis server 130.

The vehicle server 120 may include a vehicle data platform. The vehicle server 120 may process and provide accumulated driving information collected from at least one or more vehicles 110 in a form of application programming interface (API) that a user is able to utilize. When there is a plurality of second collection rules generated by the remote diagnosis server 130, the vehicle server 120 may receive the plurality of second collection rules and determine to maintain the second collection rules or determine to update the second collection rules for the vehicle 110, according to setting information of each of the second collection rules.

The remote diagnosis server 130 may include a remote diagnosis service platform, and may include a platform that provides a preemptive vehicle maintenance service based on driving information collected from the at least one or more vehicles 110. The remote diagnosis server 130 may transmit the first collection rule to the at least one or more vehicles 110, and when receiving the identification number and the failure detection signal collected according to the first collection rule from the vehicle 110, transmit the second collection rule to the vehicle 110. When there is a plurality of second collection rules, the remote diagnosis server 130 may transmit the plurality of second collection rules to the vehicle server 120.

Furthermore, the remote diagnosis server 130 may receive the information collected according to the second collection rule from the vehicle 110, accurately analyze a failure state of the vehicle 110, and allow the vehicle 110 to perform a wireless update in case of a software failure.

The vehicle remote diagnosis service system according to an exemplary embodiment of the present disclosure may analyze the failure state in advance before a user visits a repair shop for a vehicle failure issue, minimizing a time required for failure diagnosis and maintenance. In the case of a software failure, customer satisfaction may be improved by allowing the software failure to be resolved through over-the-air updates without the need to visit a repair shop.

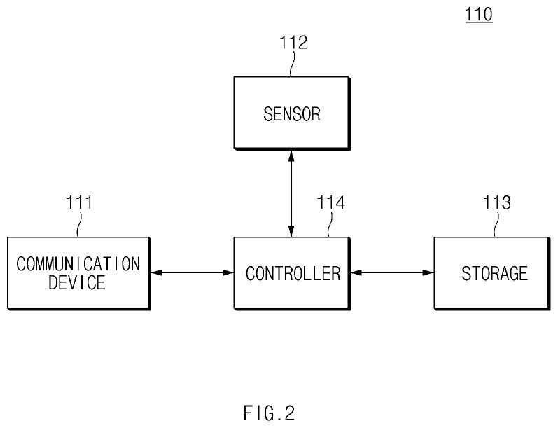

FIG. 2 is a diagram showing a configuration of a vehicle according to an exemplary embodiment of the present disclosure.

Referring to FIG. 2, the vehicle 110 according to an exemplary embodiment of the present disclosure may include a communication device 111, a sensor 112, storage 133, and a controller 114.

The communication device 111 may wirelessly communicate with the vehicle server 120 and the remote diagnosis server 130. The communication device 111 may perform wireless communication in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE), and Vehicle to Infrastructure (V2I) communication.

The sensor 112 may detect vehicle state information. According to an exemplary embodiment of the present disclosure, the sensor 112 may further include a collision sensor, a wheel sensor, a speed sensor, an inclination sensor, a weight sensor, a heading sensor, a yaw sensor, and a gyro sensor, a position module, a vehicle forward/reverse sensor, a battery sensor, a fuel sensor, a tire sensor, a steering sensor by steering-wheel rotation, a vehicle interior temperature sensor, a vehicle interior humidity sensor, an ultrasonic sensor, an illuminance sensor, a radar, a Light Detection and Ranging (LiDAR), an accelerator pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The sensor 112 may obtain a signal for vehicle collision information, vehicle direction information, vehicle location information (GPS information), vehicle angle information, vehicle speed information, vehicle acceleration information, vehicle inclination information, vehicle forward/reverse information, battery information, fuel information, tire Information, vehicle lamp information, vehicle interior temperature information, vehicle interior humidity information, steering wheel rotation angle, vehicle external illumination, or the like.

The storage 113 may store at least one or more algorithms for performing operations or execution of various commands for the operation of a vehicle according to an exemplary embodiment of the present disclosure. The storage 113 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The controller 114 may be implemented by various processing devices such as a microprocessor incorporating a semiconductor chip configured for operating or executing various instructions or the like and may control an operation of the vehicle control apparatus according to an exemplary embodiment of the present disclosure.

When receiving a first collection rule from the remote diagnosis server 130, the controller 114 may determine whether a failure corresponding to the first collection rule has occurred. According to an exemplary embodiment of the present disclosure, the controller 114 may determine whether a failure corresponding to the first collection rule has occurred based on the vehicle state information detected by the sensor.

When it is determined that a failure has occurred, which satisfies a condition for detecting a failure according to the first collection rule, the controller 114 may collect a failure detection signal according to the first collection rule and transmit an identification number and a failure detection signal to the remote diagnosis server 130. Here, the identification number may include a Vehicle Identification Number (VIN). According to the exemplary embodiment of the present disclosure, when the first collection rule is received, the controller 114 may collect the failure detection signal for a first time period around a time point at which the failure has occurred.

When receiving a second collection rule from the remote diagnosis server 130, the controller 114 may set to automatically execute the second collection rule. Accordingly, when the second collection rule is received from the remote diagnosis server 130, the controller 114 may collect information according to the second collection rule and transmit the collected information to the remote diagnosis server 130. According to an exemplary embodiment of the present disclosure, the controller 114 may collect failure-related information during a second time period. Here, the failure-related information may include detailed control data of the vehicle related to the failure.

When the remote diagnosis server 130 generates a plurality of second collection rules, the controller 114 may control execution of each second collection rule according to the determination of the vehicle server 120 to maintain or update each second collection rule.

According to the exemplary embodiment of the present disclosure, when the vehicle server 120 determines to update a (2-n)-th collection rule among the plurality of second collection rules, the controller 114 may perform control to execute the (2-n)-th collection rule when there is no (2-m)-th collection rule which is being executed among the plurality of second collection rules.

According to another exemplary embodiment of the present disclosure, in a case in which the vehicle server 120 determines to update the (2-n)-th collection rule among the plurality of second collection rules, when there is the (2-m)-th collection rule which is being executed, among the plurality of second collection rules, the controller 114 may temporarily stop the execution of the (2-m)-th collection rule, queue the (2-n)-th collection rule, restart the (2-m)-th collection rule which had been executed, and when the execution of the (2-m)-th collection rule is completed, execute the (2-n)-th collection rule.

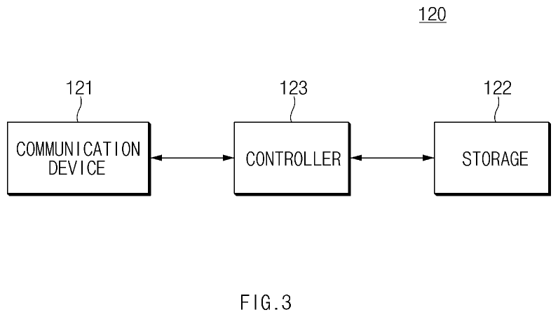

FIG. 3 is a diagram illustrating a configuration of a vehicle server according to an exemplary embodiment of the present disclosure.

Referring to FIG. 3, the vehicle server 120 may include a communication device 121, storage 122, and a controller 123.

The communication device 121 may wirelessly communicate with the vehicle 110 and the remote diagnosis server 130. The communication device 121 may perform wireless communication in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE), and Vehicle to Infrastructure (V2I) communication.

The storage 122 may store at least one or more algorithms for performing operations or execution of various commands for the operation of a vehicle according to an exemplary embodiment of the present disclosure. The storage 122 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The controller 114 may be implemented by various processing devices such as a microprocessor incorporating a semiconductor chip configured for operating or executing various instructions or the like and may control an operation of the vehicle server according to an exemplary embodiment of the present disclosure.

When a plurality of second collection rules are received from the remote diagnosis server 130, the controller 123 may determine to allow the vehicle 110 to maintain or update each of the second collection rules. According to an exemplary embodiment of the present disclosure, the controller 123 may determine to allow the vehicle 110 to maintain or update the second collection rule based on the setting information of each of the second collection rules.

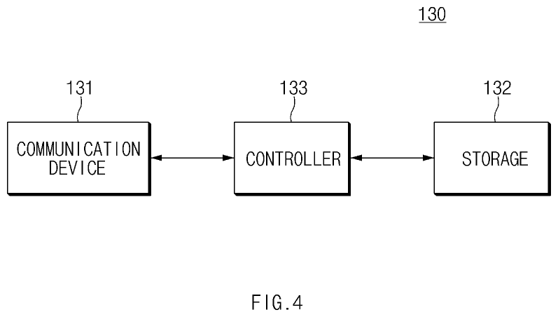

FIG. 4 is a diagram showing a configuration of a remote diagnosis server according to an exemplary embodiment of the present disclosure;

Referring to FIG. 4, the remote diagnosis server 130 may include a communication device 131, storage 132, and a controller 133.

The communication device 131 may wirelessly communicate with the vehicle 110 and the vehicle server 120. The communication device 131 may perform wireless communication in various wireless communication methods including, for example, Wi-Fi, WiBro, Global System for Mobile Communication (GSM), Code Division Multiple Access (CDMA), Wideband Code Division Multiple Access (WCDMA), Universal Mobile Telecommunication System (UMTS), Time Division Multiple Access (TDMA), Long Term Evolution (LTE), and Vehicle to Infrastructure (V2I) communication.

The storage 132 may store at least one or more algorithms for performing operations or execution of various commands for the operation of a vehicle according to an exemplary embodiment of the present disclosure. The storage 132 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The controller 133 may be implemented by various processing devices such as a microprocessor incorporating a semiconductor chip configured for operating or executing various instructions or the like and may control an operation of the server according to an exemplary embodiment of the present disclosure.

The controller 133 may transmit the first collection rule to at least one or more vehicles 110. Here, the first collection rule may include a condition for detecting a failure and collection of a failure detection signal under the condition for detecting a failure. According to an exemplary embodiment of the present disclosure, the controller 133 may set a time period for collecting the failure detection signal around a time point when a failure has occurred.

The controller 133 may constantly update the first collection rule to collect the condition for detecting a failure and the failure detection signal under the condition for detecting a failure.

When an identification number and the failure detection signal are received from the vehicle 110, the controller 133 may determine that the result of collection according to the first collection rule is received, and automatically transmit a second collection rule to the vehicle 110 which has transmitted the result of collection according to the first collection rule. Here, the second collection rule may include collection of failure-related information of the vehicle 110. According to an exemplary embodiment of the present disclosure, the controller 133 may set a time period for collecting failure-related information. When there is a plurality of second collection rules, the controller 133 may transmit the plurality of second collection rules to the vehicle server 120.

After transmitting the second collection rule, the controller 133 may analyze a failure state of the vehicle when receiving the result of collection according to the second collection rule from the vehicle 110.

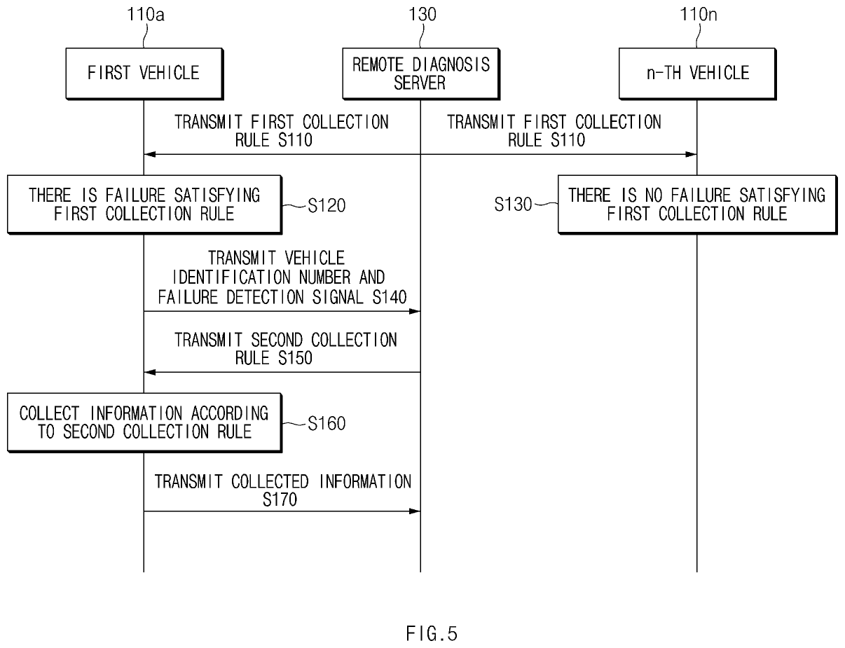

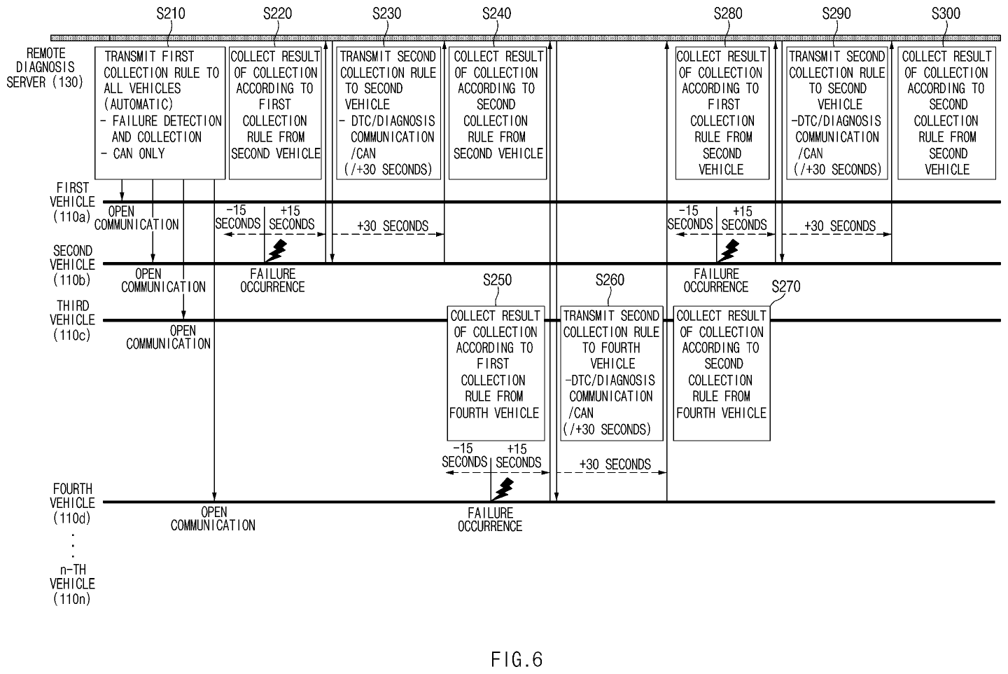

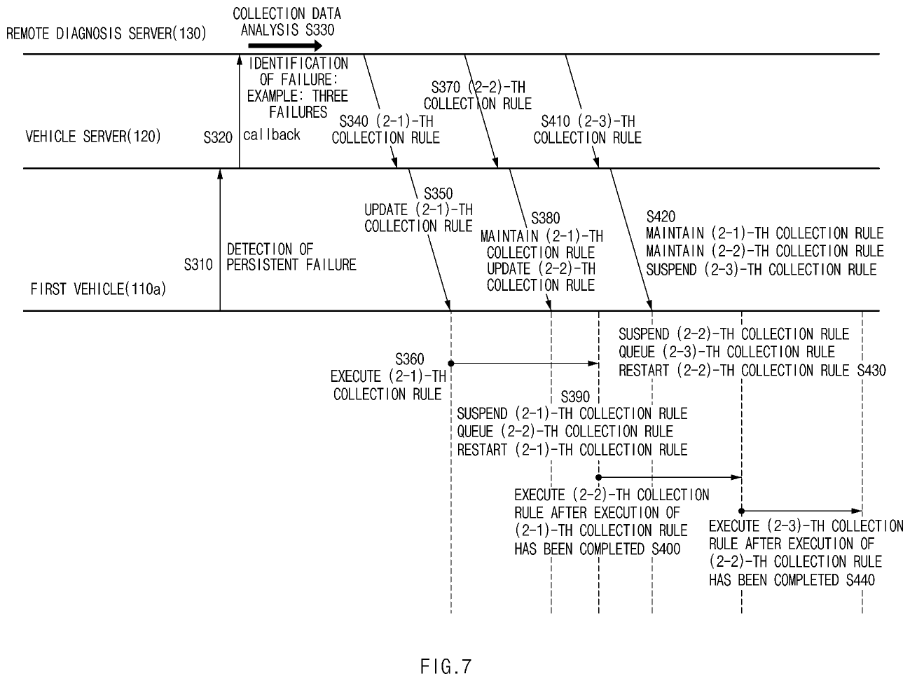

FIG. 5, FIG. 6 and FIG. 7 are diagrams illustrating a vehicle remote diagnosis service method according to an exemplary embodiment of the present disclosure.

Referring to FIG. 5, the remote diagnosis server 130 may transmit a first collection rule to at least one or more vehicles 110 (S110). Here, the first collection rule may include a condition for detecting a failure and collection of a failure detection signal under the condition for detecting a failure.

A first vehicle 110a and an n-th vehicle 110n that have received the first collection rule from the remote diagnosis server 130 may determine whether a failure satisfying the first collection rule condition has occurred. According to an exemplary embodiment of the present disclosure, the first vehicle 110a may determine that the failure satisfying the first collection rule condition has occurred (S120), and the n-th vehicle 110n may determine that the failure satisfying the first collection rule condition has not occurred (S130).

When it is determined that a failure satisfying a condition for detecting a failure has occurred according to the first collection rule, the controller 114 may collect a failure detection signal according to the first collection rule and transmit an identification number and the failure detection signal to the remote diagnosis server 130. Here, the identification number may include a Vehicle Identification Number (VIN). According to the exemplary embodiment of the present disclosure, when the first collection rule is received, the first vehicle 110a may collect the failure detection signal for a first time period around a time point at which the failure has occurred.

When the identification number and the failure detection signal are received from the first vehicle 110a, the remote diagnosis server 130 may determine that a result of collection according to the first collection rule has been received, and automatically transmit a second collection rule to the first vehicle 110a which has transmitted the result of collection according to the first collection rule (S150). The remote diagnosis server 130 does not transmit the second collection rule to the n-th vehicle 110n because the remote diagnosis server 130 has not received the result of collection according to the first collection rule from the n-th vehicle 110n. That is, the remote diagnosis server 130 of the present disclosure may allow failure-related data to be collected only from a vehicle in which a failure has occurred.

When receiving the second collection rule from the remote diagnosis server 130, the first vehicle 110a may perform settings to automatically execute the second collection rule. Accordingly, when the second collection rule is received from the remote diagnosis server 130, the vehicle 110a may collect information according to the second collection rule and transmit the collected information to the remote diagnosis server 130 (S170). According to an exemplary embodiment of the present disclosure, the first vehicle 110a may collect failure-related information during a second time period. Here, the failure-related information may include detailed control data of the vehicle related to the failure.

As shown in FIG. 6, when a connected communication to at least one vehicle (the first vehicle 110a, a second vehicle 110b, a third vehicle 110c, a fourth vehicle 110d or the n-th vehicle 110n) is established, the remote diagnosis server 130 may transmit the first collection rule to the at least one vehicle (S210). Here, the first collection rule may include a condition for detecting a failure and collection of a failure detection signal under the condition for detecting a failure.

When a failure has occurred in the second vehicle 110b, the second vehicle 110b may collect a failure detection signal under a condition that the failure is detected according to the first collection rule, and transmit the result of collection according to the first collection rule to the remote diagnosis server 130 (S220). According to the exemplary embodiment of the present disclosure, the second vehicle 110b may collect the failure detection signal for 15 seconds around a time point at which the failure has occurred.

The remote diagnosis server 130 may transmit the second collection rule to the second vehicle 110b (S230). Here, the second collection rule may include collection of failure-related information of the second vehicle 110b. The second vehicle 110b may collect failure-related information according to the second collection rule for about 30 seconds, and transmit a result of collection according to the second collection rule to the remote diagnosis server 130 (S240).

On the other hand, when a failure has occurred in the fourth vehicle 110d, the fourth vehicle 110d may collect a failure detection signal when the failure is detected according to the first collection rule, and transmit the result of collection according to the first collection rule to the remote diagnosis server 130 (S250). According to the exemplary embodiment of the present disclosure, the fourth vehicle 110d may collect the failure detection signal for 15 seconds around a time point at which the failure has occurred.

The remote diagnosis server 130 may transmit the second collection rule to the fourth vehicle 110d (S260). Here, the second collection rule may include collection of failure-related information of the fourth vehicle 110d. The fourth vehicle 110d may collect failure-related information according to the second collection rule for about 30 seconds, and transmit a result of collection according to the second collection rule to the remote diagnosis server 130 (S270).

Thereafter, when a failure has occurred in the second vehicle 110b, the second vehicle 110b may collect a failure detection signal when the failure is detected according to the first collection rule, and transmit the result of collection according to the first collection rule to the remote diagnosis server 130 (S280). Here, when a failure has occurred according to the setting information of the first collection rule, a result of collection according to the first collection rule in S280 may be identical to or different from a result of collection according to the first collection rule when a failure has occurred in S220. For example, when the first collection rule is set to be executed whenever a failure occurs in a vehicle, the result collected in S220 may be identical to the result collected in S280, and when the first collection rule is set to be executed only once when the same failure has occurred in the vehicle, the result collected in S280 may be different from the result collected in S280.

The remote diagnosis server 130 may transmit the second collection rule to the second vehicle 110b (S290). Here, the second collection rule may include collection of failure-related information of the second vehicle 110b. The second vehicle 110b may collect failure-related information according to the second collection rule for about 30 seconds, and transmit a result of collection according to the second collection rule to the remote diagnosis server 130 (S300).

Referring to FIG. 7, when it is determined that a failure has been detected in the first vehicle 110a, the first vehicle 110a may transmit a failure detection signal to the vehicle server 120 (S310), and the vehicle server 120 may transmit the failure detection signal to the remote diagnosis server 130 (S320).

The remote diagnosis server 130 may identify failure information by analyzing the data (e.g., failure detection signal) collected through S320 (S330). The remote diagnosis server 130 may generate a plurality of second collection rules to collect more detailed failure-related information, and sequentially transmit the plurality of second collection rules to the vehicle server 120 to apply the plurality of second collection rules the first vehicle 110a in sequence.

For example, when the vehicle server 120 receives a (2-1)-th collection rule among the plurality of second collection rules (S340), the vehicle server 120 may determine to allow the first vehicle 110a to maintain or update the (2-1)-th collection rule according to the setting information of the second collection rule.

As an exemplary embodiment of the present disclosure, when the vehicle server 120 determines to update the (2-1)-th collection rule (S350), the first vehicle 110a may execute the (2-1)-th collection rule because there is no collection rule which is being executed (S360).

When the vehicle server 120 receives a (2-2)-th collection rule (S370), for example, the vehicle server 120 may determine to allow the vehicle 110a to maintain the (2-1)-th collection rule and to update the (2-2)-th collection rule (S380).

The first vehicle 110a may temporarily suspend the execution of the (2-1)-th collection rule being executed, and queue the (2-2)-th collection rule. That is, the first vehicle 110a may perform setting to execute the (2-2)-th collection rule when the execution of the (2-1)-th collection rule has been completed. When the (2-2)-th collection rule has been queued, the first vehicle 110a may restart the execution of the (2-1)-th collection rule (S390).

Furthermore, when the execution of the (2-1)-th collection rule has been completed, the first vehicle 110a may execute the (2-2)-th collection rule (S400).

When the vehicle server 120 receives a (2-3)-th collection rule (S410), for example, the vehicle server 120 may determine to allow the vehicle 110a to maintain the (2-1)-th collection rule and the (2-2)-th collection rule, and update the (2-3)-th collection rule (S420).

The first vehicle 110a may temporarily suspend the execution of the (2-2)-th collection rule being executed, and queue the (2-3)-th collection rule. That is, the first vehicle 110a may perform setting to execute the (2-3)-th collection rule when the execution of the (2-2)-th collection rule has been completed. When the (2-3)-th collection rule has been queued, the first vehicle 110a may restart the execution of the (2-2)-th collection rule (S430).

Furthermore, when the execution of the (2-2)-th collection rule has been completed, the first vehicle 110a may execute the (2-3)-th collection rule (S440).

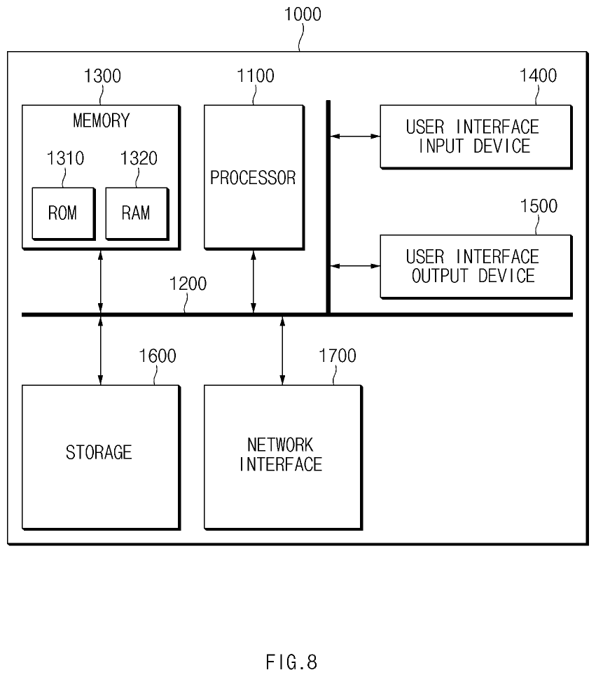

FIG. 8 a diagram showing a configuration of a computing system for executing a method according to an exemplary embodiment of the present disclosure.

Referring to FIG. 8, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the vehicle remote diagnosis service system and method according to the exemplary embodiments of the present disclosure, it is possible to apply a failure information collection rule only to a malfunctioning vehicle to collect failure-related data only from the malfunctioning vehicle, and even when a collection rule previously applied to the vehicle is being executed, allow a new collection rule to be applied to the vehicle without initialization, thus improving customer satisfaction by minimizing the time required for failure diagnosis and maintenance, by enabling over-the-air updates in case of software failures.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle remote diagnosis service system comprising:
a remote diagnosis server configured to transmit a first collection rule to at least one vehicle; and
the at least one vehicle configured to transmit an identification number and a failure detection signal collected according to the first collection rule to the remote diagnosis server when a failure corresponding to the first collection rule has occurred in the at least one vehicle, and transmit information collected according to a second collection rule to the remote diagnosis server when the second collection rule is received from the remote diagnosis server.

2. The vehicle remote diagnosis service system of claim 1, wherein the remote diagnosis server is configured to transmit the first collection rule, which includes a condition for detecting the failure and collection of the failure detection signal under the condition, to the at least one vehicle.

3. The vehicle remote diagnosis service system of claim 1, wherein the remote diagnosis server is configured to constantly update the first collection rule to collect the condition for detecting the failure and the failure detection signal under the condition.

4. The vehicle remote diagnosis service system of claim 1, wherein the remote diagnosis server is configured to perform setting to automatically transmit the second collection rule to the at least one vehicle that has transmitted the identification number when the remote diagnosis server receives the identification number and the failure detection signal.

5. The vehicle remote diagnosis service system of claim 1, wherein the remote diagnosis server is configured to transmit the second collection rule to allow the at least one vehicle that has transmitted the identification number to collect failure-related information, to the vehicle.

6. The vehicle remote diagnosis service system of claim 1, wherein the at least one vehicle is configured to automatically execute the second collection rule when the second collection rule is received from the remote diagnosis server.

7. The vehicle remote diagnosis service system of claim 1, wherein the remote diagnosis server is configured to transmit a plurality of second collection rules to a vehicle server when there is the plurality of second collection rules.

8. The vehicle remote diagnosis service system of claim 7, wherein the vehicle server is configured to determine to allow the at least one vehicle to maintain or update each of the second collection rules according to setting information of each second collection rule when the vehicle server receives the plurality of second collection rules.

9. The vehicle remote diagnosis service system of claim 8, wherein the at least one vehicle is configured to execute a (2-n)-th collection rule when the vehicle server determines to update the (2-n)-th collection rule among the plurality of second collection rules, and there is no (2-m)-th collection rule being executed among the plurality of second collection rules.

10. The vehicle remote diagnosis service system of claim 9, wherein the at least one vehicle is configured to queue a (2-n)-th collection rule when the vehicle server determines to update the (2-n)-th collection rule among the plurality of second collection rules and there is the (2-m)-th collection rule being executed among the plurality of second collection rules, and execute the (2-n)-th collection rule when execution of the (2-m)-th collection rule has been completed.

11. A vehicle remote diagnosis service method comprising:
transmitting, by a remote diagnosis server, a first collection rule to at least one vehicle;
transmitting, by the at least one vehicle, an identification number and a failure detection signal collected according to the first collection rule to the remote diagnosis server when a failure corresponding to the first collection rule has occurred in the at least one vehicle; and
transmitting, by the at least one vehicle, information collected according to a second collection rule to the remote diagnosis server when the second collection rule is received from the remote diagnosis server.

12. The vehicle remote diagnosis service method of claim 11, wherein the transmitting of the first collection rule to the at least one vehicle in the remote diagnosis server includes transmitting, by the remote diagnosis server, the first collection rule, which includes a condition for detecting the failure and collection of the failure detection signal under the condition, to the at least one vehicle.

13. The vehicle remote diagnosis service method of claim 11, further including:
constantly updating, by the remote diagnosis server, the first collection rule to collect the condition for detecting the failure and the failure detection signal under the condition.

14. The vehicle remote diagnosis service method of claim 11, further including:
performing, by the remote diagnosis server, setting to automatically transmit the second collection rule to the at least one vehicle that has transmitted the identification number when the remote diagnosis server receives the identification number and the failure detection signal.

15. The vehicle remote diagnosis service method of claim 11, further including:
transmitting, by the remote diagnosis server, the second collection rule to allow the at least one vehicle that has transmitted the identification number to collect failure-related information, to the at least one vehicle, after the transmitting of the identification number and the failure detection signal collected according to the first collection rule to the remote diagnosis server.

16. The vehicle remote diagnosis service method of claim 11, further including:
automatically executing, by the at least one vehicle, the second collection rule when the second collection rule is received from the remote diagnosis server.

17. The vehicle remote diagnosis service method of claim 15, wherein the transmitting of the second collection rule includes transmitting, by the remote diagnosis server, a plurality of second collection rules to a vehicle server when there is the plurality of second collection rules.

18. The vehicle remote diagnosis service method of claim 17, further including:
determining, by the vehicle server, to allow the vehicle to maintain or update each of the second collection rules according to setting information of each second collection rule when the vehicle server receives the plurality of second collection rules.

19. The vehicle remote diagnosis service method of claim 18, further including:
executing, by the at least one vehicle, a (2-n)-th collection rule when the vehicle server determines to update the (2-n)-th collection rule among the plurality of second collection rules and there is no (2-m)-th collection rule being executed among the plurality of second collection rules.

20. The vehicle remote diagnosis service method of claim 18, further including:
queueing, by the at least one vehicle, a (2-n)-th collection rule when the vehicle server determines to update the (2-n)-th collection rule among the plurality of second collection rules and there is the (2-m)-th collection rule being executed among the plurality of second collection rules, and execute the (2-n)-th collection rule when execution of the (2-m)-th collection rule has been completed.
